(19) United States
(12) Patent Application Publication
(10) Pub. No.: US 2024/0384959 A1
(43) Pub. Date: Nov. 21, 2024

(54) SYSTEM AND METHOD INCORPORATING AI AND HUMAN CAPABILITIES IN A GUN

(71) Applicant: ROBERT M ALLAN, LA JOLLA, CA (US)

(72) Inventor: ROBERT M ALLAN, LA JOLLA, CA (US)

(21) Appl. No.: 18/198,573

(22) Filed: May 17, 2023

(51) Int. Cl. F41A 17/08

(52) U.S. Cl. CPC F41A 17/08; F41A 17/066; F41G 3/165; G06V 10/764; G06V 20/50; G06V 40/10

(57) ABSTRACT

An AI device, attached to or in a firearm, a processor, camera, front and rear lens, laser to assist sighting. AI identifies “friend” or “foe” images on camera screen. Trademarked: AI GUN™. “Friend” or “foe” images are framed on camera's screen. “Friends” are child heads, family members, 2+people, police uniforms & badges, military uniforms with American Flag patches etc., AI un-blocks trigger for non-friends-“foes”. Pressed trigger authorizes firing. AI fires the gun at framed target. Shooter aims laser to target. AI locks trigger if “friends” are in view. With military use side camera screen shooter sees what the gun is aimed at while protected behind cover. When laser beam crosses framed “foe”, gun fires accurately, additional firing is possible with more framed targets. AI approves or denies user. Unauthorized use triggers alarm and flashing light. Facial recognition, fingerprint image or PIN code lock is used.

### CROSS REFERENCE TO RELATED APPLICATIONS

Not applicable

### FEDERALLY SPONSORED RESEARCH AND DEVELOPMENT

Not applicable

### JOINT RESEARCH AGREEMENT

Not applicable

### REFERENCE TO MATERIAL SUBMITTED ON A COMPACT DISC

Not applicable

### PRIOR ART

U.S. Pat. No. 4,467,545A
U.S. Pat. No. 5,062,232A
U.S. Pat. No. 5,448,847A
U.S. Pat. No. 5,946,840A
U.S. Pat. No. 6,098,330A
U.S. Pat. No. 6,260,300B1
U.S. Pat. No. 6,286,242B1
U.S. Pat. No. 6,301,815B1
U.S. Pat. No. 6,412,207B1
U.S. Pat. No. 6,421,943B1
U.S. Pat. No. 6,442,880B1
US20020170220A1
US20030115786A1
US20030136043A1
U.S. Pat. No. 6,678,984B1
US20050000139A1
U.S. Pat. No. 6,843,014B1
US2006024879A1
US20070186457A1
US20070209267A1
US20100251881A1
US20110056108A1
US20110061280A1
US20120090213A1
U.S. Pat. No. 8,235,031 B2
US20120291326A1
US20130118050A1
US20140366419A1
US20150040453A1
U.S. Pat. No. 9,032,657B1
US20160054081A1
US20160054083A1
US20160091267A1
US20160156636A1
U.S. Pat. No. 9,441,896B2
US20160341506A1
US20170077741A1
US20170102199A1
US20170108304A1
US20170146310A1
US20170205170A1
U.S. Pat. No. 2,327,334A
U.S. Pat. No. 3,634,963A
U.S. Pat. No. 4,467,545A
U.S. Pat. No. 4,541,191A
U.S. Pat. No. 5,020,259A
U.S. Pat. No. 5,357,704A
U.S. Pat. No. 5,449,103A
U.S. Pat. No. 5,448,847A
U.S. Pat. No. 5,502,915A
U.S. Pat. No. 5,621,996A
U.S. Pat. No. 5,735,070A
U.S. Pat. No. 5,860,241A
U.S. Pat. No. 6,125,568A
U.S. Pat. No. 6,286,242B1
U.S. Pat. No. 6,293,039B1
U.S. Pat. No. 6,442,880B1
US20020178635A1
U.S. Pat. No. 6,735,897B1
US20050066567A1
US20050188583A1
U.S. Pat. No. 6,943,665B2
U.S. Pat. No. 7,155,034B1
U.S. Pat. No. 7,216,449B2
US20070175955A1
U.S. Pat. No. 7,339,456B1
US20080060246A1
U.S. Pat. No. 7,506,468B2
U.S. Pat. No. 7,703,229B2
US20110056108A1
US20110061280A1
U.S. Pat. No. 7,966,759B2
US20110247950A1
US20120011756A1
U.S. Pat. No. 8,205,372B2
US20130019510A1
U.S. Pat. No. 8,418,391B2
US20130125441A1
US20130167423A1
US20130318847A1
US20140259841A1
US20150040453A1
US20150135935A1
U.S. Pat. No. 91,134,083B2

### BACKGROUND OF THE INVENTION

When my son was five I used a S&W 357 Magnum for home defense. I did not like having a hidden loaded gun with kids around, then my grandfather gave me a shoe box with a loaded 9 MM luger my grandfather's brother had taken from a German in WWI. Half the rounds were 9 MM with a white powder in their hollow point, likely garlic. Half the rounds were 7.22 MM which could still have rattled down the barrel. Germans must have been short of ammo and desperate. The luger was a good childproof gun as without a round on the chamber it was too hard to cock for a kid. As my son got older, I thought there must be a better solution. Years later Smith & Wesson offered to buy my first patent, on terms that made no sense. I have been awarded multiple patents on guns with internal safety. Now my son is sixty something and I am filing this patent combining AI with a hand and long gun.

### BRIEF DESCRIPTION OF DRAWINGS

The present invention is illustrated by way of example, and not by way of limitation, in the figures of the accompanying drawings and in which like reference numerals refer to similar elements and in which:

FIG. 1 illustrates a detailed perspective view of an AI GUN™, a hand gun with AI assembly (1) attached to or as a part of a gun in an embodiment of the present invention.

FIG. 2 illustrates a rear view of the AI GUN™, the hand gun of FIG. 1 with components and the AI assembly attached in an embodiment of the present invention.

FIG. 3 illustrates a front view of the AI GUN™, the hand gun of FIG. 1 with components attached in an embodiment of the present invention.

FIG. 4 illustrates the trigger area of the left side view of the AI GUN of FIG. 1, showing trigger is blocked by blocker pin that has a notch, the back of trigger can fit in when the motor (2) pulls the blocker and its pin, in an embodiment of the present invention.

FIG. 5 illustrates a detailed perspective view of a long AI GUN™, with AI assembly, camera lens (117) and optional camera screen (113) that may be attached to both sides of or as a part of a long gun in an embodiment of the present invention.

FIG. 6 illustrates a front view of FIG. 5 bracket (124) with laser, camera lens and light.

FIG. 7 illustrates the brackets front facing portion with camera lens, light; and

FIG. 8 is a sequence diagram that illustrates an AI GUN™ processor operation.

### DETAILED DESCRIPTION OF THE INVENTION

The present invention is perhaps best described by the claims. An AI device that may be included in a gun that is a firearm, that includes a camera, AI processor, facial recognition software, and a laser. The processor uses AI to compare images and classifies them as friend or foe. Friend images would include family members, children with smaller head sizes than adults, a group of two or more people, people with their hands up, police officers in uniforms with badges, military with approved country flag patches and custom images. Foes generally would be non-friend and custom images. The device has a camera with at least a front facing lens, an AI processor and may have side and rear facing camera lens, a motor and battery compartment, a trigger blocking or electronic firing device.

In a favorite embodiment of a rifle that may be an AR 15 type gun and may be configured for military or use, the camera has a side mounted removable viewing screen that may be adjustable to use on either side of the gun or there would be a left and right screen. The AI rifle may be held at about arms length while the shooter is behind full cover using the camera's side mounted screen to sight the gun, assisted by the gun's laser and AI. The camera's screen would frame objects its AI processor would classify as friends or foes. Facial recognition like software would prevent the AI GUN™ from firing at images classified as friends, but pick out foes as potential targets. The gun has a has a laser, the beam of which is calibrated to the spot the bullet will hit. The shooter views the target area and laser beam using the camera's screen. When the shooter moves or swipes the laser beam over a framed foe, the AI processor would allow the AI GUN to fire, providing the shooter was authorizing firing by depressing the trigger, otherwise the gun would not shoot. Thus, the AI processor fires the gun if firing has been authorized and aimed properly. Additional viewed framed foes may also be fired at with additional swiping of laser beam over framed targets. Rapid and accurate firing at foe targets may occur more than otherwise possible. The AI GUN™ may use AI electronic firing and make fine aim adjustment using AI to assist in moving GUN's aim.

An embodiment of the invention may combine the AI GUN™ with a drone so that the gun may be positioned to take advantage of its abilities to identify and fire accurately at foe targets.

An embodiment of the invention is a gun (3) being a pistol of FIG. 1 having a rear facing camera lens (22) to take shooters facial image and unlock the gun, otherwise if the gun is picked up, the gun would sense this as grip sensors or movement would alert the AI and trigger the alarm to sound if the images include facial, finger and/or palm print do not match authorized images. The forward facing camera lens (6) has zoom settings (23, 24) on assembly (22) with sensors on the grip (17,18).

An embodiment of the AI GUN™ may be used for home defense and kept in a drawer next to the bed or under the owners driver side seat. The gun would have an assembly of components (1) that include a tilt meter or accelerometer (15), and would be stored on its side. If an unauthorized person or thief picks up the gun, the tilt meter or accelerometer would wake the processor (12) and start a 10 second countdown to the guns alarm (26), which would sound along with the light flashing (7). For the owner or authorized user, the facial recognition software would unlock the gun. AI does not give the unauthorized user ten seconds to unlock but takes their picture if the gun is not unlocked. Grip sensors also wake the processor. Unlocking can use a keyboard (10) to use 3 or more digit PIN codes, Facial recognition typically can unlock the gun using Camera lens at back of gun (21) or at alternative location on side may be used (9). Rear facing lens may be on component carrier (19) or incorporated into gun at that location; alternate lens location (9) may be used, a lens to take a palmprint or finger print lock (16, 25) would also unlock gun. The assembly (1) would include a laser (8) that's beam could be seen in vicinity of target on camera screen (20), a battery compartment (14), a motor (2) to move the trigger blocker (4) to block the trigger with a pin in unblocked position (28) and blocking trigger position (27) with trigger nested in notch of pin so that the gun cannot fire.

A forward facing camera lens (6) view would be shown on camera screen (20), camera picture can be zoomed in and out with buttons at (21, 22,23). Shooter would aim the gun so that the laser beam crosses the target, in war for example a human torso, which would be framed by processor and camera's software on cameras screen. If the shooter is authorizing the gun to fire by depressing the trigger the AI processor would cause the gun to fire. The shooter then shifts the laser's beam and repeated fire at more targets in the area with little time spent on aiming. The transmitter may broadcast the guns GPS location if the gun is being used by the military or police. If a police officer draws his or her gun the gun's transmitter (13) can notify police headquarters. The gun would have a light switch (11).

The AI GUN™ can be programmed to remain unlocked if desired but forward aimed lens would lock gun if pointed at programmed friends.

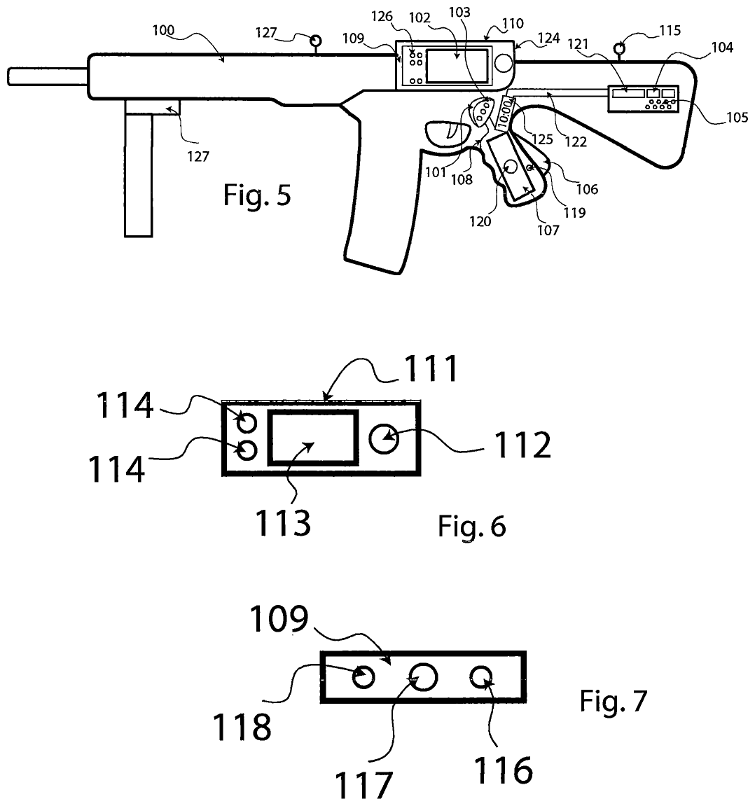

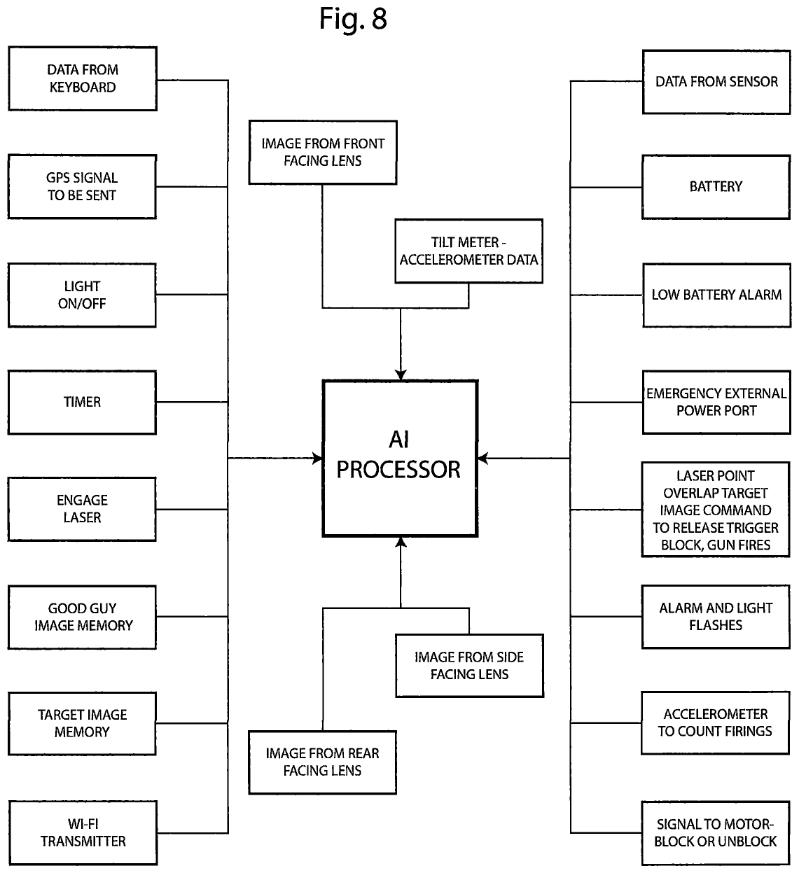

FIG. 5 is a long gun of this AI GUN invention. The long gun would have a laser (116) that can be seen on the camera's screen (102, 113) when the AI GUN™ is pointed. The long gun can be held conventionally with the butt of the stock on the shooters shoulder or at arm's length from the shooter so that he or she may view what the gun is pointed at on the side mounted camera screen and operate the AI GUN™ from full cover, only exposing some of the gun in order for the camera lens to view the target area and fire. Like a cell phone camera that view images where people heads are recognized as heads and framed to better focus, with the AI GUN™ head and torso are framed as targets. Facial recognition software would be programmed to classify certain images as friends and others as foes. The processor is programmed to lock the trigger using a trigger blocker (122). When the processor compares stored images classified as Friends”, processor will not let firing pin to let gun shoot. Images of friends would include family members, police officers in uniform with badges, children because their heads are small, a group as small as 2 persons and owner's discretionary friends. Kids in a classroom would be protected as groups of 2 or more are protected. Not protected would be paper targets, non-friend torsos or images.

The military AI GUN™ would be programmed as desired by the military unit. It is expected the military of a nation would wear that nation's flag patches that would be recognized as friends by AI GUNS™. Police uniforms with badges would work like flag patches.

A military impact would be the side with the AI GUNs™ could operate the AI GUN™ from cover with AI assisted rapidly accurate firing. To operate the AI GUN™ the shooter would press the trigger down to authorize the gun to fire when the laser beam contacts the framed target of a foe displayed on the cameras screen, the AI would fire the gun. If there are more framed targets after the initial firing, additional firings could occur. The AI would be doing the firing as long as the shooter aimed the gun and was pressing the trigger.

The AI GUN™ for police or military use may use a GPS and transmission device to alert headquarters if gun has been drawn, moved or fired.

The AI GUN™, pistol or long gun can be programmed to be unlocked for any desired time period potentially satisfying gun owners who oppose guns that contain an internal lock that must unlocked to use the gun.

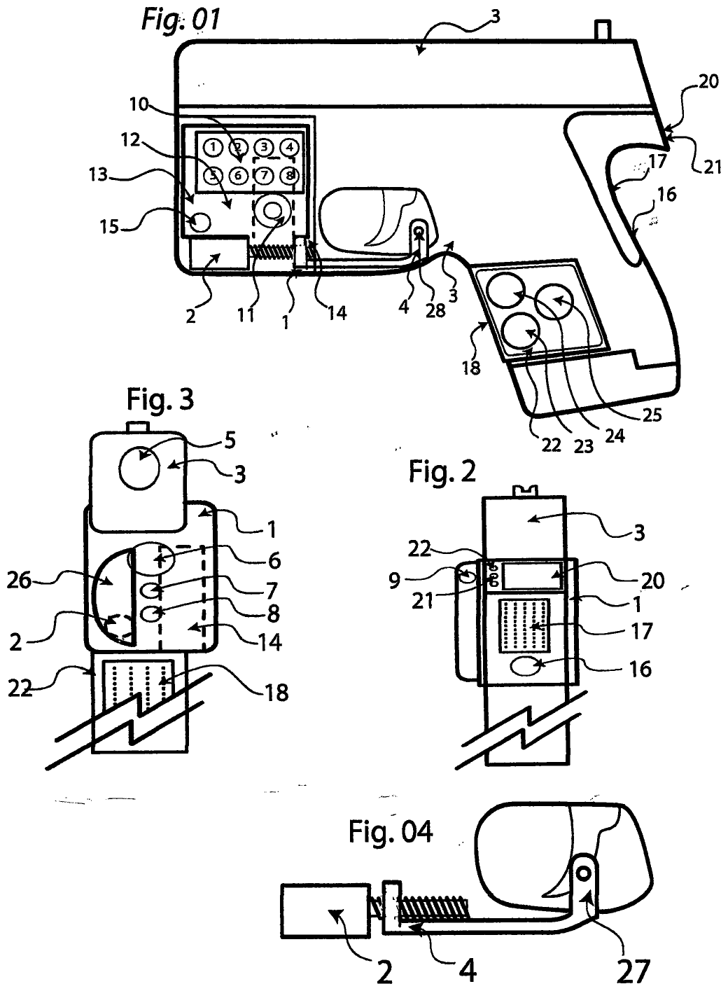

In an embodiment depicted at FIG. 1 an accelerometer or motion detector (15, 119) detects if the gun is tilted 90 degrees, as for example if a handgun (3) is stored on its side in a drawer or under a car seat and picked up tilting the gun 90 degrees, the processor (13) is alerted and starts a countdown, such as 10 seconds. Lights (21), FIG. 2 alerts the user there is a countdown and blinks until the gun unlocks or the alarm sounds. The rear facing lens (20) or at (9) provide facial image of person holding the gun to the processor for identification and unauthorized user's face would be photographed. Alternately a police officer could use their badge instead of facial image. The fingerprint/palm print reader lens (25) also provides an image that may be used for unlocking. A back up keyboard (10) can provide PIN code unlocking. If the gun is not unlocked in say 10 seconds the alarm (26) will begin to sound, the light (6) will begin to flash and the transmitter in police embodiments will transmit the officer's location, whether the gun is unlocked or not. It is believed most departments want to know when their officers draw their guns. Grip sensors (17 and 22) with the transmitter in the processor can trigger transmittal of the GPS location.

The camera in police embodiments will record when the gun is drawn getting a better recording than body worn cameras. A pressure sensitive switch (17) is mounted on a holder (19), can signal the processor when the gun is no longer held, taken, or just put down and relock the gun. A lens to read a palm at (16) or a fingerprint/palm can be located on the side of the grip at (25). Alternatively, the accelerometer or a lens that stops viewing might be used to signal the processor to lock the gun when gun is not held. Embodiment at FIG. 3 shows a forward facing light (6) with a laser (7) and camera lens (8). Three volt batteries are in compartment (14).

The illustrated embodiment locking assembly (1) has a motor (2) configured to move a trigger blocker (4) on both sides of the trigger with a pin (28) that in FIG. 1 is back allowing the trigger to be pulled. FIG. 4 illustrates the trigger blocker pin (27) with a slot engaging the trigger so that it cannot be pushed through when it locks the trigger. The locking assembly contains a keyboard for programming and back up PIN code unlocking. A forward grip pressure switch (18) may be used by the processor to instantly lock the gun if the holder is disarmed or just puts the gun down.

The camera's forward facing lens can be used for target practice to analyze performance, and to put the target area on the Camera's screen. The assembly if attached to a shotgun can permit a bird hunter to improve by recording if they have been leading too much or not enough by recording shots and sending them to a cell phone. For police the camera on hand and long guns can provide a more accurate record than a body camera of a police shooting. For the military the gun could be programmed not to shoot at individuals with approved country flags on their uniforms.

The camera's software can be programmed to prevent school and mass shootings as follows: The gun will lock if in the field of view heads are smaller, child size, or there are groups of 2 or more, like in a classroom, or people in the field of view are wearing school or police uniforms or police badges.

The same software can lock the gun if family members faces are programmed into the gun as well as police officer's faces. The gun will lock if police uniforms or badges are identified. As some individuals oppose any electronic trigger locks, the gun can be programmed so that the rear lens and fingerprint unlocking can be disengaged, so that the gun works just like a conventional gun, however would still use the front lens to trigger locking.

What is claimed:

1. An AI device assembly is claimed comprising of components configured as part of or attached to a firearm, herein after referred to as a gun. The device having a camera with a front facing camera lens, the lens and said camera configured to provide images of where the gun is pointed that may be on a screen, a AI processor that contains software that may be able to identify and classify images as friend or foes. Police in uniforms with badges, family members, children due to small heads, groups of 2 or more people, people with their hands up, military with approved id images such as country flags, approved finger and palm prints or objects, and compare viewed images with stored images, in order to classify images as friend or foe. Images classified as foes may be displayed on a camera screen along with the device's laser beam. The screen and processor may frame foe images and when the shooter adjusted his aim so the laser beam meets a designated framed foe image, the AI fires the gun providing a human is authorizing firing. Said authorizing may be by the pulling of the guns trigger, or by the pressing of a button or switch which may be at a remote location. Said firing may be initiated mechanically, electronically or by a combination of both.

2. A gun containing at least a camera lens and AI processor that may take images so that the gun's AI may verify the person attempting to operate the device is authorized and unlock or lock as programmed and if unauthorized may sound an alarm, may cause the light to begin to flash, take pictures, and or in addition under the following circumstances if the gun is unlocked may lock the trigger mechanism: i) if images are classified as children, because the software recognizes they have child size heads, ii) the camera views a group of 2 or more persons, iii) family members are recognized due to facial identification, iv) police officers are recognized due to their uniform, and or badges v) members of the military are recognized if they are wearing their country flag patch or programmed identification, that are classified as friends and vi) people are holding up their hands.

3. An assembly of components incorporated into or attached to a gun including front and rear orientated camera lens that may contain a processor, battery compartment, a motor, a tilt meter and/or a accelerometer, a switch configured to wake a processor and start a countdown to the device's alarm, configured to sound and may sound after 10 seconds if the countdown has not stopped due to the unlocking of the device, that may include an authorized image, facial identification of an authorized individual, palm or fingerprint identification or the entering of a PIN code in the device's keyboard.

4. The device of claim 1 where the AI determines the motion detected by the accelerometer may indicate the gun will potentially be fired and triggers the camera to record for 10 seconds, or as programmed.

5. The gun of claim 1 that may be used by the police or military and may contain GPS location software, a camera and forward facing lens and may contain means to inform a remote site, that may be headquarters, the guns location and may inform if the gun has been drawn, moved, or fired, may start the camera recording and if a long gun, removed from the trunk of a squad car, and signal headquarters the GPS location.

6. The combination of the device of claim 1 and a drone, and/or props or rotors, configured to give the device and gun a stabilized platform, the device being capable of flying over an enemy position and may or may not use a cable to raise and lower the gun to a desired height from a drone.

7. The AI GUN™, of claim 1 having gyroscope assisted aiming.

8. The AI GUN of claim 1 having motor means to adjust guns aim to correspond to laser beam.
